(19) United States
(12) Patent Application Publication
(10) Pub. No.: US 2018/0082646 A1
(43) Pub. Date: Mar. 22, 2018

(54) FIELD SEQUENTIAL COLOR TYPE DISPLAY DEVICE AND CONTROL METHOD THEREFOR

(71) Applicant: SHARP KABUSHIKI KAISHA, Sakai City, Osaka (JP)

(72) Inventor: NORIAKI YAMAGUCHI, Sakai City (JP)

(21) Appl. No.: 15/560,995

(22) PCT Filed: Mar. 18, 2016
(86) PCT No.: PCT/JP2016/058643

§ 371 Date: Sep. 22, 2017

(30) Foreign Application Priority Data
Mar. 25, 2015 (JP) 2015-062357

(51) Int. Cl. G09G 3/34; G09G 3/20

(52) U.S. Cl. CPC G09G 3/3413; G09G 2320/0626; G09G 3/2003

(57) ABSTRACT

A display device (10) includes a display panel (11), a backlight (12) having a switchable light emission color, a display control circuit (15), and a finish signal output unit (16). The finish signal output unit (16) outputs a finish signal (C1) for instructing turn off of the backlight (12) at an arbitrary timing. The display control circuit (15) divides one frame period into a plurality of subfield periods, and outputs backlight data (D1) and a video signal (V2) including subfield data in each subfield period. When detecting the finish signal (C1), the display control circuit (15) turns off the backlight (12) after controlling the display panel (11) and the backlight (12) so that an achromatic color subfield is displayed. With this, unnatural display when turning off the backlight can be prevented.

### TECHNICAL FIELD

The present invention relates to a display device, and especially to a field sequential color type display device and a control method therefor.

### BACKGROUND ART

A field sequential color type display device has been conventionally known. For example, a field sequential color type display device which displays three subfields in one frame period includes a display panel without a color filter and a backlight having a light emission color switchable to red, green, and blue. One frame period is divided into three subfield periods. In a first subfield period, the display panel displays an image based on blue subfield data and the backlight emits light in blue. With this, a blue subfield is displayed. Similarly, a green subfield is displayed in a second subfield period, and a red subfield is displayed in a third subfield period. The observer recognizes the blue, green, and red subfields displayed successively as a color image. The field sequential color type display device performs color display by the above principle.

Some field sequential color type display devices display four or more subfields. For example, there is known a field sequential color type display device which displays subfields of white, cyan, magenta, yellow, or the like in addition to the blue, green, and red subfields.

Relating to the invention of the present application, Patent Document 1 discloses that a color breakup and a flicker can be suppressed by displaying a white subfield before or after displaying subfields of other colors and setting display brightness of white to be lower than those of the other colors, in the field sequential color type display device.

### PRIOR ART DOCUMENT

### Patent Document

[Patent Document 1] Japanese Laid-Open Patent Publication No. 2009-53475

### SUMMARY OF THE INVENTION

### Problems to be Solved by the Invention

The backlight included in the display device is turned off, for example, when power is turned off. The conventional field sequential color type display device has a problem that when the backlight is turned off, a single color subfield such as blue, green, red, or the like is displayed immediately before the backlight is turned off (refer to FIG. 3 described later). The observer strongly recognizes, as an afterglow, the color (red in FIG. 3) of the subfield displayed immediately before the backlight is turned off, and feels that unnatural display is performed. Such unnatural display occurs not only when the power is turned off but also in other cases such as when the backlight is turned off.

Accordingly, an object of the present invention is to provide a field sequential color type display device which prevents unnatural display when the backlight is turned off.

### Means for Solving the Problems

According to a first aspect of the present invention, there is provided a field sequential color type display device including: a display panel; a backlight having a switchable light emission color; a display control circuit configured to divide one frame period into a plurality of subfield periods, and control the display panel and the backlight by outputting subfield data and backlight data in each subfield period; and a turn off instructing unit configured to output a turn off instruction of the backlight at an arbitrary timing, wherein the display control circuit is configured to, when detecting the turn off instruction, turn off the backlight after controlling the display panel and the backlight so that an achromatic color subfield is displayed.

According to a second aspect of the present invention, in the first aspect of the present invention, the display control circuit is configured to detect the turn off instruction every subfield period.

According to a third aspect of the present invention, in the second aspect of the present invention, the display control circuit is configured to perform a finish process of the display panel after turning off the backlight in accordance with the turn off instruction.

According to a fourth aspect of the present invention, in the second aspect of the present invention, the display control circuit is configured to control the display panel and the backlight so that a subfield which follows a subfield displayed before displaying the achromatic color subfield is displayed, after turning off the backlight in accordance with the turn off instruction.

According to a fifth aspect of the present invention, in the third or fourth aspect of the present invention, the display control circuit is configured to control the display panel and the backlight so that a plurality of subfields not including the achromatic color subfield are displayed in one frame period, until detecting the turn off instruction.

According to a sixth aspect of the present invention, in the second aspect of the present invention, the display control circuit is configured to control the display panel and the backlight so that a plurality of subfields including the achromatic color subfield are displayed in one frame period until detecting the turn off instruction, retain the turn off instruction when detecting the turn off instruction, and turn off the backlight in accordance with the retained turn off instruction after controlling the display panel and the backlight so that the achromatic color subfield is displayed.

According to a seventh aspect of the present invention, in the first aspect of the present invention, the achromatic color subfield is a white subfield.

According to an eighth aspect of the present invention, in the first aspect of the present invention, the display control circuit is configured to, when detecting the turn off instruction, control the display panel and the backlight so that one achromatic color subfield is displayed.

According to a ninth aspect of the present invention, in the first aspect of the present invention, a part of the backlight that overlaps with the display panel is formed of a transparent material.

According to a tenth aspect of the present invention, there is provided a control method for a field sequential color type display device including a display panel and a backlight having a switchable light emission color, the method including the steps of: dividing one frame period into a plurality of subfield periods and controlling the display panel and the backlight by outputting subfield data and backlight data in each subfield period; and outputting a turn off instruction of the backlight at an arbitrary timing, wherein in the controlling, when the turn off instruction is detected, the backlight is turned off after controlling the display panel and the backlight so that an achromatic color subfield is displayed.

### Effects of the Invention

According to the first or tenth aspect of the present invention, when the turn off instruction is output, the achromatic color subfield is displayed before the backlight is turned off. Therefore, when the backlight is turned off, it is possible to prevent the hue of the light emission color of the backlight from changing and prevent unnatural display.

According to the second aspect of the present invention, when the turn off instruction is output, it is possible to promptly perform a process of displaying the achromatic color subfield and turning off the backlight.

According to the third aspect of the present invention, it is possible to prevent the unnatural display when the backlight is turned off in the display device in which the turn off instruction is output when display is finished.

According to the fourth aspect of the present invention, it is possible to prevent the unnatural display when the backlight is turned off in the display device which performs display even after the turn off instruction is output.

According to the fifth aspect of the present invention, in the display device which does not display the achromatic color subfield in a normal state, it is possible to prevent the unnatural display when the backlight is turned off, by displaying the achromatic color subfield before the backlight is turned off when the turn off instruction is output.

According to the sixth aspect of the present invention, in the display device which displays the achromatic color subfield in a normal state, it is possible to prevent the unnatural display when the backlight is turned off, by displaying the achromatic color subfield before the backlight is turned off. Furthermore, it is possible to easily perform a process when the turn off instruction is detected, by retaining the detected turn off instruction and turning off the backlight in accordance with the retained turn off instruction after displaying the achromatic color subfield.

According to the seventh aspect of the present invention, it is possible to prevent the unnatural display when the backlight is turned off by displaying the white subfield as the achromatic color subfield.

According to the eighth aspect of the present invention, it is possible to display the achromatic color subfield for a short time when the turn off instruction is output and prevent the unnatural display when the backlight is turned off, by displaying one achromatic color subfield before the backlight is turned off.

According to the ninth aspect of the present invention, it is possible to prevent the unnatural display when the backlight is turned off in the display device having a function of showing a space behind the display screen.

### BRIEF DESCRIPTION OF THE DRAWINGS

FIG. 1 is a block diagram showing a configuration of a display device according to a first embodiment of the present invention.

FIG. 2 is a flowchart showing operations of a display control circuit of the display device shown in FIG. 1.

FIG. 3 is a diagram showing changes of a light emission color of a backlight when the backlight is turned off in a conventional display device.

FIG. 4 is a diagram showing changes of a light emission color of a backlight when the backlight is turned off in the display device shown in FIG. 1.

FIG. 5 is a block diagram showing a configuration of a display device according to a second embodiment of the present invention.

FIG. 6 is a flowchart showing operations of a display control circuit of the display device shown in FIG. 6.

FIG. 7 is a flowchart of a turn on/turn off switching process of the display device shown in FIG. 6.

FIG. 8 is a flowchart showing operations of a display control circuit of a display device according to a third embodiment of the present invention.

FIG. 9 is a flowchart of a turn on/turn off switching process of the display device according to the third embodiment of the present invention.

FIG. 10 is a block diagram showing a configuration of a display device according to a reference example.

FIG. 11 is a diagram showing vertical synchronization signals of video signals in the display device shown in FIG. 10.

FIG. 12 is a flowchart showing operations of a display control circuit of the display device shown in FIG. 10.

### MODES FOR CARRYING OUT THE INVENTION

### First Embodiment

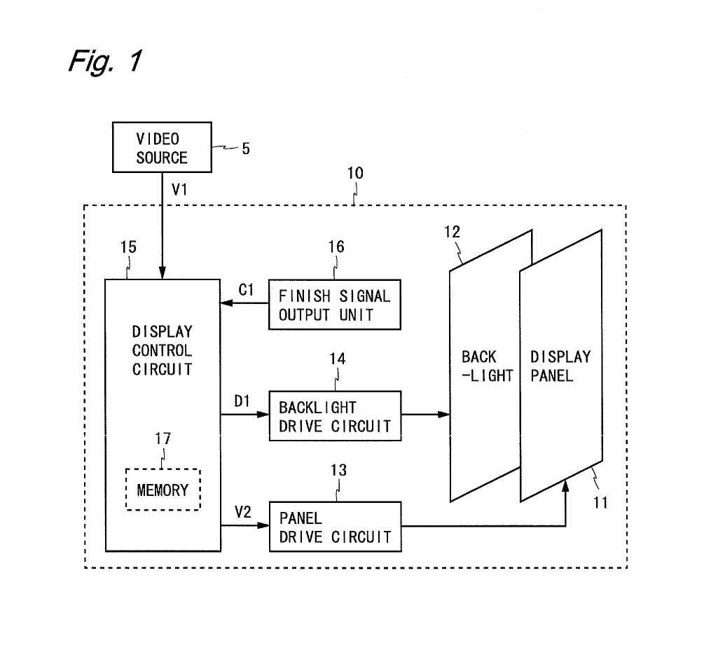

FIG. 1 is a block diagram showing a configuration of a display device according to a first embodiment of the present invention. A display device 10 shown in FIG. 1 is a field sequential color type display device. The display device 10 includes a display panel 11, a backlight 12, a panel drive circuit 13, a backlight drive circuit 14, a display control circuit 15, and a finish signal output unit 16. The display control circuit 15 includes a memory 17. A video source 5 is provided outside the display device 10.

The display panel 11 is a display panel without a color filter. The display panel 11 has a plurality of pixels (not shown) arranged two-dimensionally. Transmittance of the pixel changes in accordance with data written to the pixel. As the display panel 11, a liquid crystal panel without a color filter is used, for example. As the display panel 11, there can be used a display panel in which transmittance of the pixel is controlled by mechanically controlling a direction of a shutter corresponding to the pixel, a display panel in which transmittance of the pixel is controlled by electrically moving a liquid drop in a cell corresponding to the pixel, or the like.

The backlight 12 is a surface type light source having a wavelength spectrum of at least red, green, and blue, and a light emission color switchable to at least red, green, blue, and white. The backlight 12 is arranged in a back side of the display panel 11 and irradiates a back surface of the display panel 11 with light. As the backlight 12, a direct type backlight in which red LEDs (Light Emitting Diodes), green LEDs, and blue LEDs are arranged two-dimensionally, or an edge type backlight obtained by forming red LEDs, green LEDs, and blue LEDs in a bar shape and arranging a light emitting member formed in the bar shape on a side surface of a light guide plate is used, for example.

The video source 5 outputs a video signal V1 to the display device 10. A frame rate of the video signal V1 is 60 frames/second, for example. Based on the video signal V1, the display control circuit 15 outputs a video signal V2 to the panel drive circuit 13 and outputs backlight data D1 to the backlight drive circuit 14. The panel drive circuit 13 drives the display panel 11 based on the video signal V2. The backlight drive circuit 14 drives the backlight 12 based on the backlight data D1.

The display control circuit 15 divides one frame period into n (n is an integer not less than 3) subfield periods, and controls the display panel 11 and the backlight 12 by outputting the backlight data D1 and the video signal V2 including subfield data in each subfield period. A frame rate of the video signal V2 is (60× n) frames/second, for example. In a first subfield period, the panel drive circuit 13 drives the display panel 11 based on first subfield data included in the video signal V2. The backlight drive circuit 14 controls the light emission color of the backlight 12 to be a color of a first subfield, based on the backlight data D1 indicating the color of the first subfield. With this, the first subfield is displayed. Similarly, a second subfield is displayed in a second subfield period, and a third subfield is displayed in a third subfield period. When n is not less than 4, fourth to n-th subfields are displayed in fourth to n-th subfield periods, respectively. It is possible to perform color display using the display panel 11 without a color filter by thus displaying n subfields in one frame period.

When a predetermined operation (for example, a power off button is pressed) is performed, the finish signal output unit 16 outputs a finish signal C1 to the display control circuit 15. The finish signal output unit 16 functions as a turn off instructing unit for outputting a turn off instruction of the backlight 12 at an arbitrary timing.

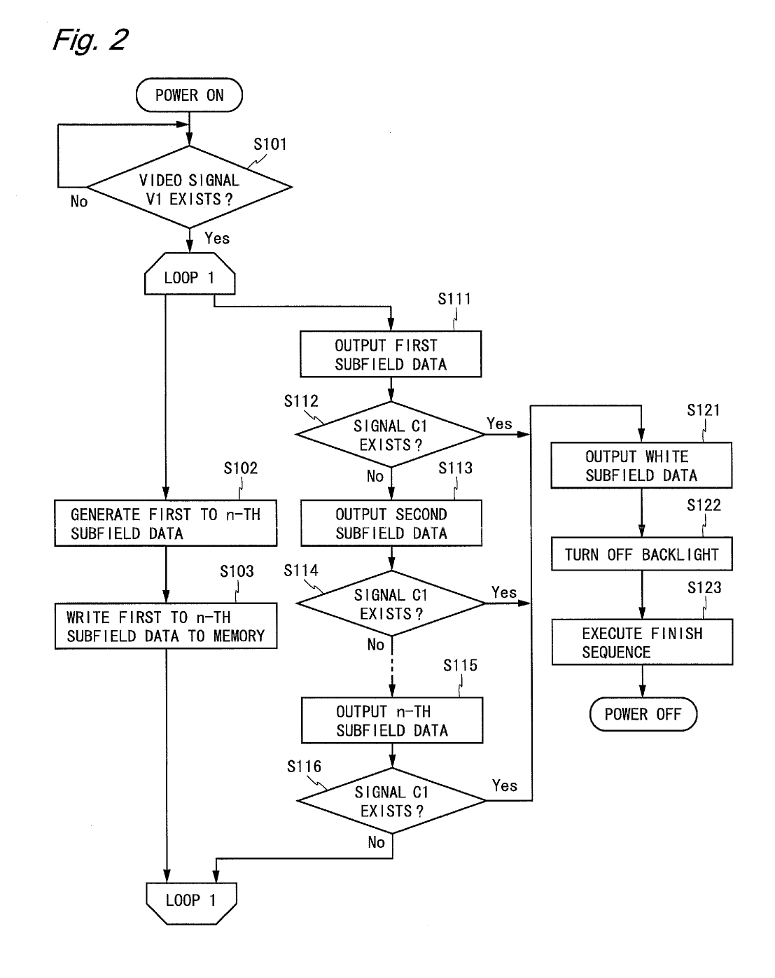

FIG. 2 is a flowchart showing operations of the display control circuit 15. FIG. 2 describes the operations from power on to power off. After power on, the display control circuit 15 waits until the video signal V1 is output from the video source 5 (step S101). When the video signal V1 is output from the video source 5, the display control circuit 15 performs a process of writing subfield data to the memory 17 based on the video signal V1 (hereinafter referred to as data generation process) and a process of outputting the video signal V2 including the subfield data read from the memory 17 (hereinafter referred to as data output process). The display control circuit 15 performs these processes in parallel repeatedly, each once in one frame period (loop 1).

In the data generation process, the display control circuit 15 generates first to n-th subfield data based on the video signal V1 output from the video source 5 (step S102). Next, the display control circuit 15 writes the generated first to n-th subfield data to the memory 17 (step S103).

In the data output process, at first, the display control circuit 15 outputs the first subfield data together with the backlight data D1 indicating the color of the first subfield (step S111). In step S111, the display control circuit 15 reads the first subfield data from the memory 17 and outputs the video signal V2 including the first subfield data. At this time, the panel drive circuit 13 drives the display panel 11 based on the first subfield data, and the backlight drive circuit 14 controls the light emission color of the backlight 12 to be the color of the first subfield. With this, the first subfield is displayed. Next, the display control circuit 15 determines whether the finish signal C1 is output from the finish signal output unit 16 (step S112). The display control circuit 15 goes to step S121 when Yes is determined, and goes to step S113 when No is determined.

In the latter case, the display control circuit 15 outputs the second subfield data together with the backlight data D1 indicating the color of the second subfield (step S113). In step S113, the display control circuit 15 reads the second subfield data from the memory 17 and outputs the video signal V2 including the second subfield data. At this time, the panel drive circuit 13 drives the display panel 11 based on the second subfield data, and the backlight drive circuit 14 controls the light emission color of the backlight 12 to be the color of the second subfield. With this, the second subfield is displayed. Next, the display control circuit 15 determines whether the finish signal C1 is output from the finish signal output unit 16 (step S114). The display control circuit 15 goes to step S121 when Yes is determined, and goes to a step (not shown) for outputting the third subfield data when No is determined.

After that, the display control circuit 15 sequentially performs a process for outputting the third to n-th subfield data together with the backlight data D1 indicating the colors of the third to n-th subfields. When outputting the n-th subfield data together with the backlight data D1 indicating the color of the n-th subfield (step S115), the display control circuit 15 reads the n-th subfield data from the memory 17, and outputs the video signal V2 including the n-th subfield data. At this time, the panel drive circuit 13 drives the display panel 11 based on the n-th subfield data, and the backlight drive circuit 14 controls the light emission color of the backlight 12 to be the color of the n-th subfield. With this, the n-th subfield is displayed. Next, the display control circuit 15 determines whether the finish signal C1 is output from the finish signal output unit 16 (step S116). The display control circuit 15 goes to step S121 when Yes is determined, and goes to an end of the loop 1 when No is determined.

When the finish signal C1 is detected in the data output process, the display control circuit 15 outputs white subfield data together with the backlight data D1 indicating white (step S121). The white subfield data is obtained by extracting an achromatic color portion of the video signal V1. The display control circuit 15 generates the white subfield data and outputs the video signal V2 including the white subfield data. At this time, the panel drive circuit 13 drives the display panel 11 based on the white subfield data, and the backlight drive circuit 14 controls the light emission color of the backlight 12 to be white. With this, a white subfield is displayed.

After one subfield period has passed, the display control circuit 15 outputs the backlight data D1 indicating turn off (step S122). After step S122, the backlight 12 is turned off. Next, the display control circuit 15 performs a finish sequence of the display panel 11 as a finish process of the display panel 11 (step S123). For example, in a case where the display panel 11 is a liquid crystal panel, if power is suddenly turned off while displaying an image on the liquid crystal panel, burn-in occurs in the liquid crystal panel. In step S123, the display control circuit 15 performs the finish sequence for preventing the burn-in on the liquid crystal panel before the power supplied to the liquid crystal panel is turned off.

In this manner, the display control circuit 15 detects the finish signal C1 every subfield period. When detecting the finish signal C1, the display control circuit 15 turns off the backlight 12 after controlling the display panel 11 and the backlight 12 so that the white subfield is displayed. The display control circuit 15 performs the finish sequence of the display panel 11 after turning off the backlight 12 in accordance with the finish signal C1.

In the following, effects of the display device 10 according to the present embodiment will be described, compared with a display device which performs steps S122, S123 without performing step S121 when the finish signal C1 is detected (hereinafter referred to as conventional display device). Here, it is assumed that the conventional display device and the display device 10 sequentially display blue, green, and red subfields in one frame period. Furthermore, it is assumed that the light emission colors of the backlight are blue, green, and red in the first to third subfield periods, respectively, and the backlight is turned off after a fourth subfield.

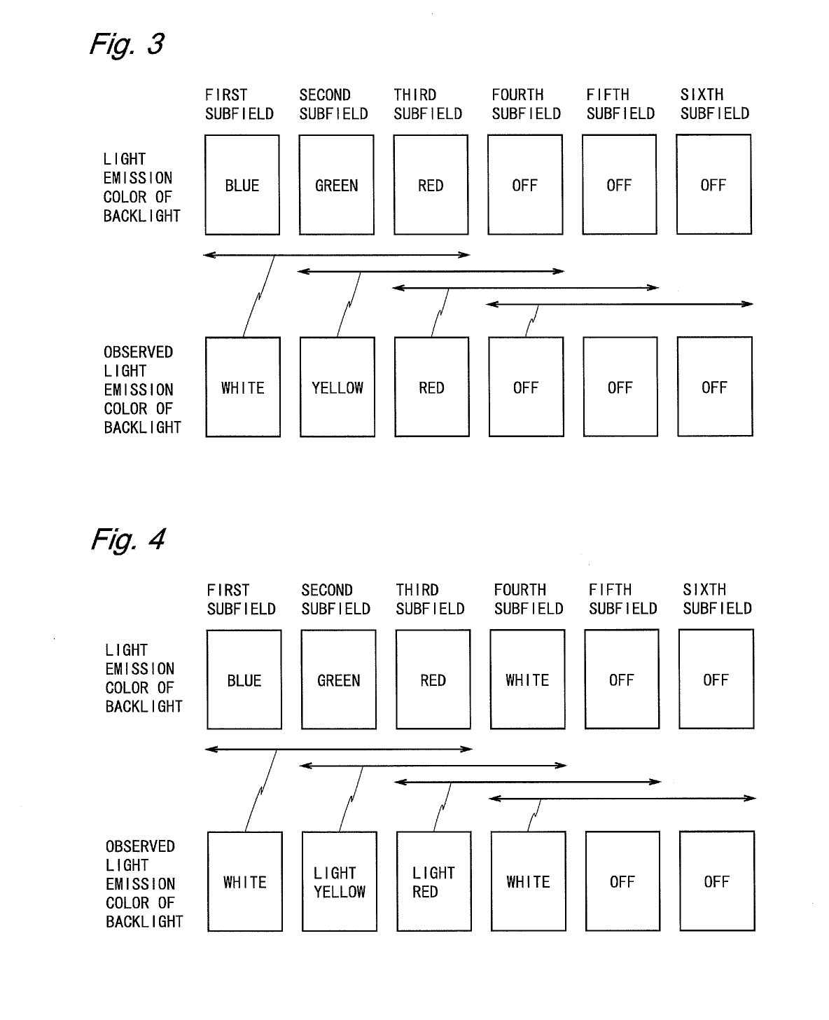

FIG. 3 is a diagram showing changes of the light emission color of the backlight when the backlight is turned off in the conventional display device. The observer recognizes a color obtained by composing the light emission colors of the backlight in a plurality of subfield periods. In an example shown in FIG. 3, when the backlight is turned off, the observer recognizes that the light emission color of the backlight sequentially changes from white to yellow (mixed color of green and red), red, and off (black). The observer strongly recognizes red as an afterglow, the red being a color of a subfield displayed immediately before the backlight is turned off. In this manner, in the conventional display device, when the backlight is turned off, the observer sees a single color subfield displayed immediately before the backlight is turned off and feels that unnatural display is performed.

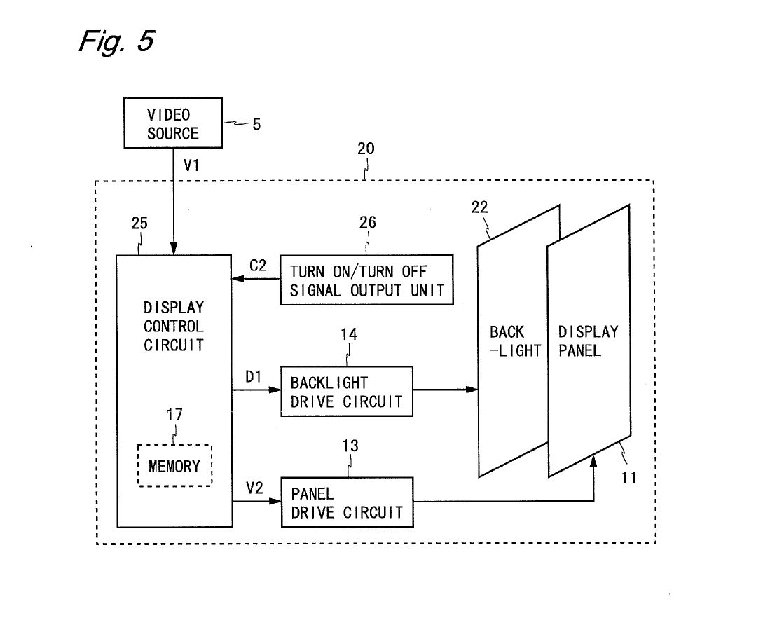

FIG. 4 is a diagram showing changes of the light emission color of the backlight when the backlight is turned off in the display device 10 according to the present embodiment. Since the display device 10 performs the process shown in FIG. 2, the light emission color of the backlight 12 becomes white for one subfield period before being turned off. Thus, in an example shown in FIG. 4, when the backlight is turned off, the observer recognizes that the color of the backlight sequentially changes from white to light yellow, light red, white, and off (black). The color of the subfield displayed immediately before the backlight 12 is turned off is white. When the backlight 12 is turned off, since the light emission color of the backlight 12 changes from white to black, the hue of the light emission color of the backlight 12 does not change. Thus, the observer does not recognize white as the afterglow, the white being the color of the subfield displayed immediately before the backlight is turned off. Therefore, according to the display device 10 according to the present embodiment, it is possible to prevent the observer from seeing the single color subfield when the backlight 12 is turned off and prevent the unnatural display when the backlight is turned off.

As described above, the display device 10 according to the present embodiment includes the display panel 11, the backlight 12 having a switchable light emission color, the display control circuit 15 for dividing one frame period into the plurality of the subfield periods and controlling the display panel 11 and the backlight 12 by outputting the subfield data and the backlight data D1 in each subfield period, and a turn off instructing unit (finish signal output unit 16) for outputting a turn off instruction (finish signal C1) of the backlight 12 at an arbitrary timing. When detecting the turn off instruction, the display control circuit 15 turns off the backlight 12 after controlling the display panel 11 and the backlight 12 so that an achromatic color subfield (white subfield) is displayed. In this manner, in the display device 10, when the turn off instruction is output, the achromatic color subfield is displayed before the backlight 12 is turned off. Therefore, when the backlight 12 is turned off, it is possible to prevent the hue of the light emission color of the backlight 12 from changing and prevent the unnatural display.

Furthermore, the display control circuit 15 detects the turn off instruction every subfield period. Therefore, when the turn off instruction is output, it is possible to promptly perform a process of displaying the achromatic color subfield and turning off the backlight 12. Furthermore, the display control circuit 15 performs a finish process (finish sequence) of the display panel 11 after turning off the backlight 12 in accordance with the turn off instruction. Therefore, it is possible to prevent the unnatural display when the backlight 12 is turned off in the display device 10 in which the turn off instruction is output when display is finished. Furthermore, when detecting the turn off instruction, the display control circuit 15 controls the display panel 11 and the backlight 12 so that one white subfield is displayed as the achromatic color subfield. Therefore, it is possible to display the white subfield for a short time when the turn off instruction is output and prevent the unnatural display when the backlight 12 is turned off.

Note that the display device 10 according to the present embodiment may display a plurality of subfields not including the achromatic color subfield in one frame period (for example, displays three subfields of blue, green, and red), or may display a plurality of subfields including the achromatic color subfield in one frame period (for example, displays four subfields of blue, green, red, and white).

In the former case, the display control circuit 15 controls the display panel 11 and the backlight 12 so that a plurality of subfields not including the achromatic color subfield are displayed in one frame period, until detecting the turn off instruction. In this case, in the display device which does not display the achromatic color subfield in a normal state, it is possible to prevent the unnatural display when the backlight 12 is turned off, by displaying the achromatic color subfield before the backlight 12 is turned off when the turn off instruction is output.

### Second Embodiment

FIG. 5 is a block diagram showing a configuration of a display device according to a second embodiment of the present invention. A display device 20 shown in FIG. 5 is a field sequential color type display device, and is also a see-through type display device having a function of showing behind a display screen transparently. The display device 20 includes the display panel 11, a backlight 22, the panel drive circuit 13, the backlight drive circuit 14, a display control circuit 25, and a turn on/turn off signal output unit 26. In the following, among components of each embodiment, the same components as those in the previously described embodiment are provided with the same reference numbers, and their descriptions are omitted.

As with the backlight 12 according to the first embodiment, the backlight 22 is a surface type light source having a wavelength spectrum of at least red, green, and blue, and a light emission color switchable to at least red, green, blue, and white. However, a part of the backlight 22 that overlaps with the display panel 11 is made of a transparent material. As the backlight 22, an edge type backlight is used, for example.

As with the display control circuit 15 according to the first embodiment, the display control circuit 25 divides one frame period into n (n is an integer not less than 3) subfield periods, and controls the display panel 11 and the backlight 22 by outputting the backlight data D1 and the video signal V2 including the subfield data in each subfield period. The display control circuit 25 performs operations different from those of the display control circuit 15.

When a predetermined operation (for example, a backlight turn on/turn off button is pressed) is performed, the turn on/turn off signal output unit 26 outputs a turn on/turn off switching signal C2 to the display control circuit 25. The turn on/turn off switching signal C2 instructs switching of a turn on/turn off state of the backlight 22. When the turn on/turn off switching signal C2 is output while the backlight 22 is on, the backlight 22 is turned off. When the turn on/turn off switching signal C2 is output while the backlight 22 is off, the backlight 22 is turned on. As with the finish signal output unit 16 according to the first embodiment, the turn on/turn off signal output unit 26 functions as a turn off instructing unit for outputting a turn off instruction of the backlight 22 at an arbitrary timing.

When the backlight 22 is on, the observer sees a color image displayed on the display panel 11. On the other hand, when the backlight 22 is off, the observer sees a monochrome image displayed on the display panel 11 and also sees a space behind the display screen transparently through a high brightness portion (portion including high transmittance pixels) in the image. In this manner, the display device 20 selectively performs a normal display and a transparent display in which the space behind the display screen can be seen transparently, by switching the turn on/turn off state of the backlight 22.

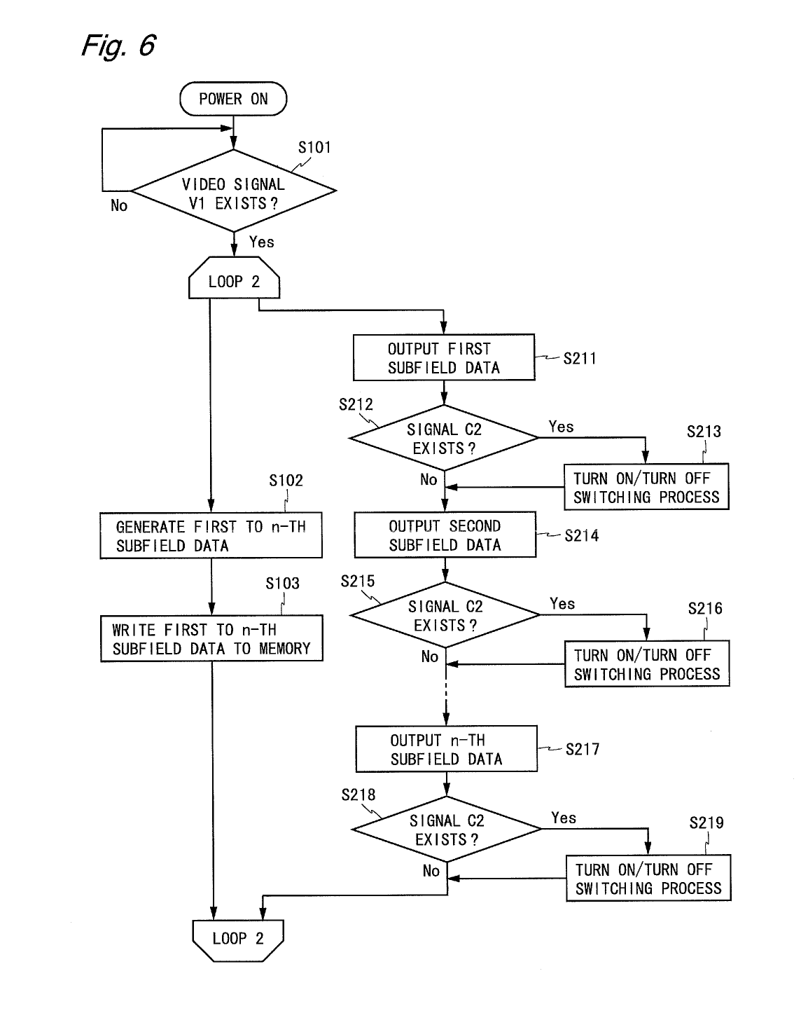

FIG. 6 is a flowchart showing operations of the display control circuit 25. FIG. 6 describes the operations after power on. In the following, differences from the flowchart shown in FIG. 2 will be mainly described. When the video signal V1 is output from the video source 5, the display control circuit 25 performs the data generation process and the data output process. The display control circuit 25 performs these processes in parallel repeatedly, each once in one frame period (loop 2). Details of the data generation process are the same as those in the first embodiment.

In the data output process, at first, the display control circuit 25 outputs the first subfield data together with the backlight data D1 indicating the color of the first subfield (step S211). Details of step S211 are the same as those of step S111 shown in FIG. 2. Next, the display control circuit 25 determines whether the turn on/turn off switching signal C2 is output from the turn on/turn off signal output unit 26 (step S212). The display control circuit 25 immediately goes to step S214 when No is determined, and performs a turn on/turn off switching process (step S213) and then goes to step S214 when Yes is determined.

Next, the display control circuit 25 outputs the second subfield data together with the backlight data D1 indicating the color of the second subfield (step S214). Next, the display control circuit 25 determines whether the turn on/turn off switching signal C2 is output from the turn on/turn off signal output unit 26 (step S215). The display control circuit 25 immediately goes to a step (not shown) for outputting the third subfield data when No is determined. The display control circuit 25 performs the turn on/turn off switching process (step S216) and then goes to a step for outputting the third subfield data when Yes is determined.

After that, the display control circuit 25 sequentially performs a process for outputting the third to n-th subfield data together with the backlight data D1 indicating the colors of the third to n-th subfields. In step S217, the display control circuit 25 outputs the n-th subfield data together with the backlight data D1 indicating the color of the n-th subfield. Next, the display control circuit 25 determines whether the turn on/turn off switching signal C2 is output from the turn on/turn off signal output unit 26 (step S218). The display control circuit 25 immediately goes to an end of the loop 2 when No is determined, and performs the turn on/turn off switching process (step S219) and then goes to the end of the loop 2 when Yes is determined.

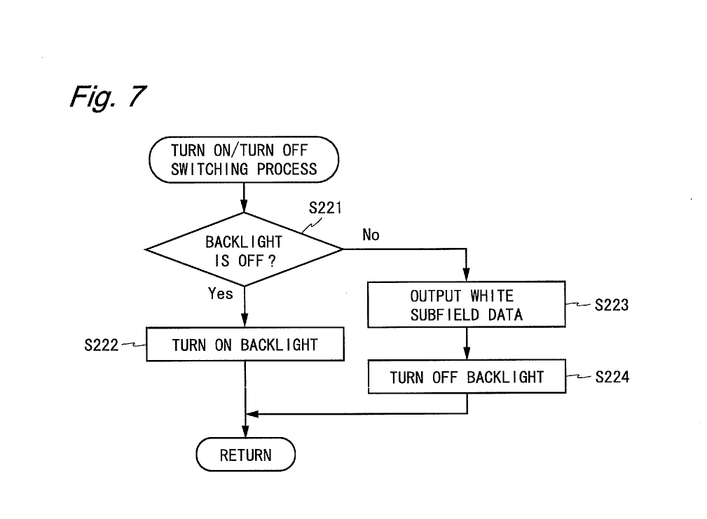

FIG. 7 is a flowchart of the turn on/turn off switching process. In the turn on/turn off switching process, at first, the display control circuit 25 determines whether the backlight 22 is off (step S221). The display control circuit 25 goes to step S222 when Yes is determined, and goes to step S223 when No is determined. In the former case, the display control circuit 25 outputs the backlight data D1 indicating turn on (step S222). After step S222, the backlight 22 is turned on. In the latter case, the display control circuit 25 outputs the white subfield data together with the backlight data D1 indicating white (step S223). Details of step S223 are the same as those of step S121 shown in FIG. 2. After one subfield period has passed, the display control circuit 25 outputs the backlight data D1 indicating turn off (step S224). After step S224, the backlight 22 is turned off. The display control circuit 25 finishes the turn on/turn off switching process after performing step S222 or step S224.

When the backlight 22 is turned on in the turn on/turn off switching process, a subfield which follows a subfield displayed immediately before is displayed in the next subfield period. When the backlight 22 is turned off in the turn on/turn off switching process, a subfield which follows a subfield displayed before displaying the white subfield is displayed in the next subfield period.

In this manner, the display control circuit 25 detects the turn on/turn off switching signal C2 every subfield period. When the turn on/turn off switching signal C2 is detected while the backlight 22 is off, the display control circuit 25 turns on the backlight 22 immediately. When the turn on/turn off switching signal C2 is detected while the backlight 22 is on, the display control circuit 25 turns off the backlight 22 after controlling the display panel 11 and the backlight 22 so that the white subfield is displayed. The display control circuit 25 controls the display panel 11 and the backlight 22 so that a subfield which follows a subfield displayed before displaying the white subfield is displayed, after turning off the backlight 22 in accordance with the turn on/turn off switching signal C2.

As described above, in the display device 20 according to the present embodiment, when detecting the turn off instruction (turn on/turn off switching signal C2), the display control circuit 25 turns off the backlight 22 after controlling the display panel 11 and the backlight 22 so that the achromatic color subfield (white subfield) is displayed. Therefore, as with the first embodiment, when the backlight 22 is turned off, it is possible to prevent the hue of the light emission color of the backlight 22 from greatly changing and prevent the unnatural display.

Furthermore, the display control circuit 25 controls the display panel 11 and the backlight 22 so that a subfield which follows a subfield displayed before displaying the achromatic color subfield is displayed, after turning off the backlight 22 in accordance with the turn off instruction. Therefore, it is possible to prevent the unnatural display when the backlight 22 is turned off in the display device 20 which performs display even after the turn off instruction is output. Furthermore, a part of the backlight 22 that overlaps with the display panel 11 is made of a transparent material. Therefore, it is possible to prevent the unnatural display when the backlight 22 is turned off in the display device 20 having the function of showing behind the display screen.

As with the first embodiment, the display device 20 according to the present embodiment may display a plurality of subfields not including the achromatic color subfield in one frame period, or may display a plurality of subfields including the achromatic color subfield in one frame period.

### Third Embodiment

A display device according to a third embodiment of the present invention has a same configuration as that of the display device 20 according to the second embodiment (refer to FIG. 5). The display control circuit 25 according to the present embodiment divides one frame period into n (n is an integer not less than 4) subfield periods, and controls the display panel 11 and the backlight 22 by outputting the backlight data D1 and the video signal V2 including subfield data in each subfield period. In the n-th subfield period, the white subfield is displayed.

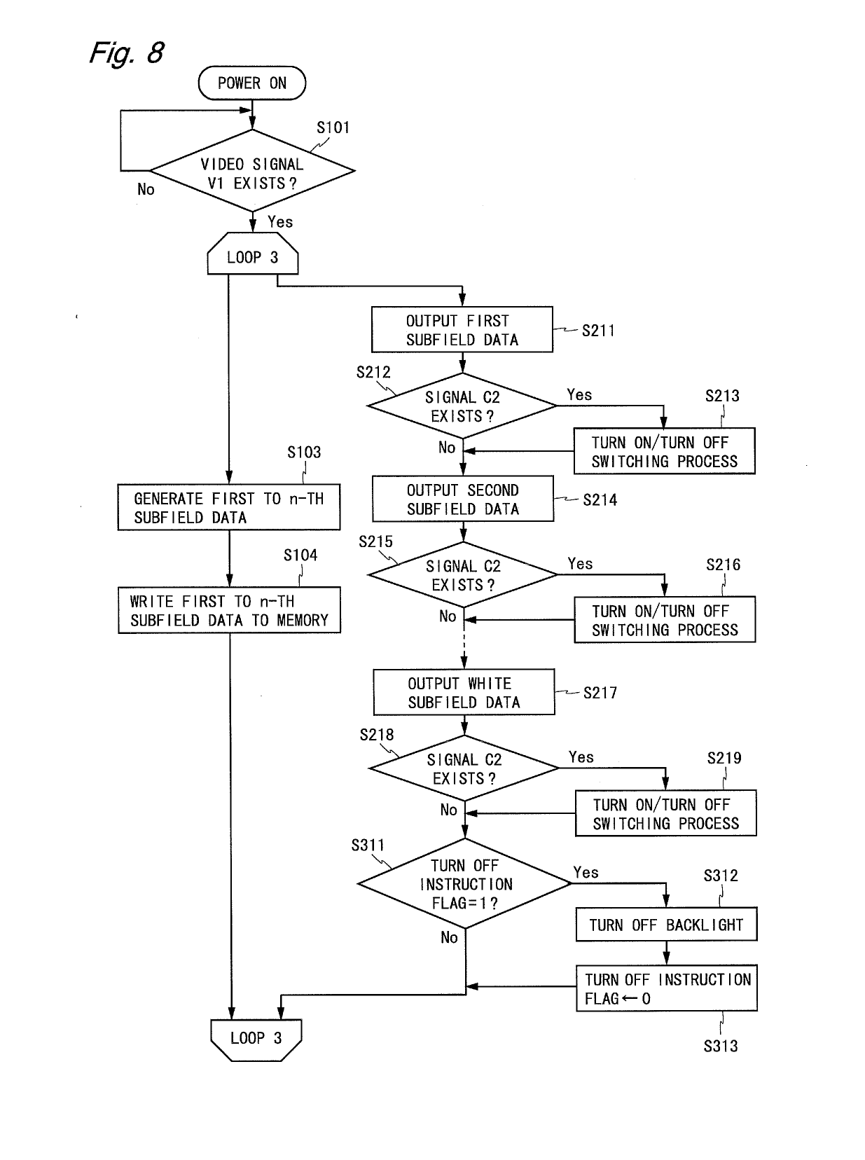

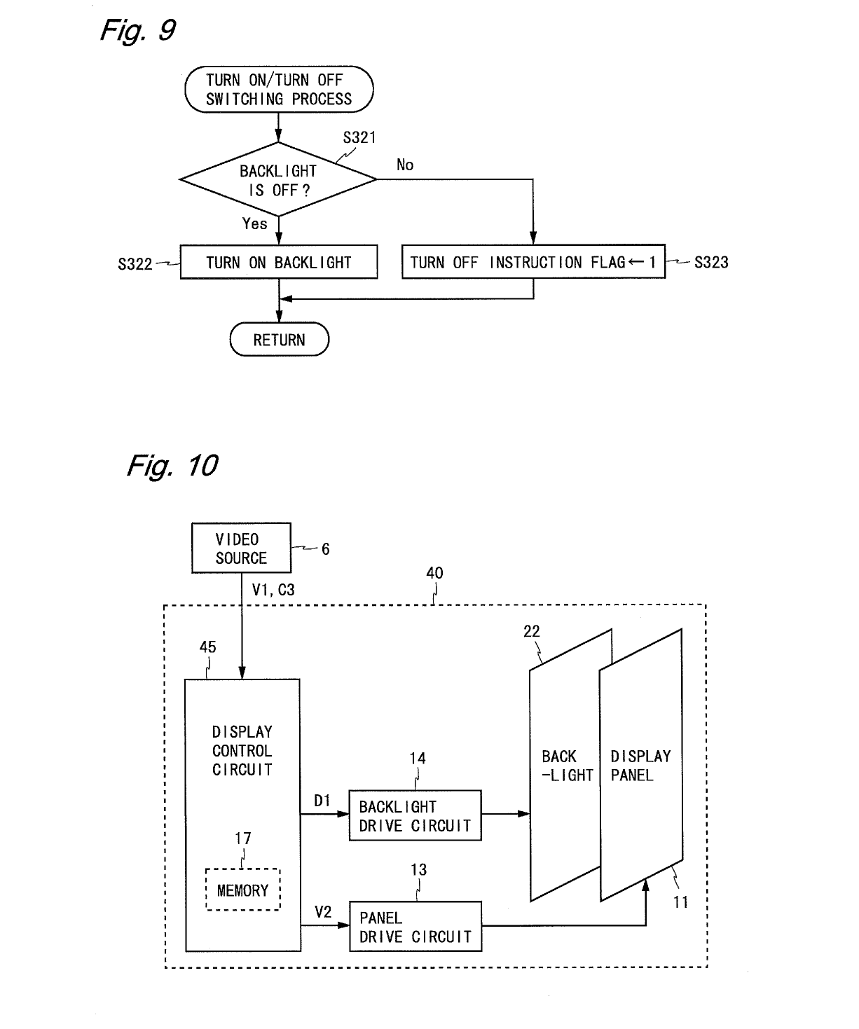

FIG. 8 is a flowchart showing operations of the display control circuit 25 according to the present embodiment. FIG. 8 describes the operations after power on. FIG. 9 is a flowchart of the turn on/turn off switching process. In the following, differences from the flowcharts shown in FIGS. 6 and 7 will be mainly described. The display control circuit 25 uses a turn off instruction flag indicating that a turn off instruction of the backlight 22 is received. The turn off instruction flag is set to 0 (no instruction) in an initial state.

The flowchart shown in FIG. 8 is obtained by adding steps S311 to S313 to the flowchart shown in FIG. 6. When the video signal V1 is output from the video source 5, the display control circuit 25 performs the data generation process and the data output process. The display control circuit 25 performs these processes in parallel repeatedly, each once in one frame period (loop 3).

The display control circuit 25 goes to step S311 after performing step S218 or S219 in the data output process. In step S311, the display control circuit 25 determines whether the turn off instruction flag is 1 (instruction exists). The display control circuit 25 immediately goes to an end of the loop 3 when No is determined. When Yes is determined, the display control circuit 25 outputs the backlight data D1 indicating turn off (step S312), sets the turn off instruction flag to 0 (step S313), and then goes to the end of the loop 3.

In this manner, the display control circuit 25 detects the turn on/turn off switching signal C2 every subfield period. When the turn on/turn off switching signal C2 is detected while the backlight 22 is off, the display control circuit 25 turns on the backlight 22 immediately. When the turn on/turn off switching signal C2 is detected while the backlight 22 is on, the display control circuit 25 sets the turn off instruction flag to 1. The backlight 22 continues to be on even after the turn off instruction flag is set to 1, until the white subfield is displayed in the n-th subfield period. If the turn off instruction flag is 1 after the white subfield is displayed in the n-th subfield period, the display control circuit 25 turns off the backlight 22.

In the turn on/turn off switching process (FIG. 9), at first, the display control circuit 25 determines whether the backlight 22 is off (step S321). The display control circuit 25 outputs the backlight data D1 indicating turn on (step S322) when Yes is determined, and sets the turn off instruction flag to 1 (instruction exists) (step S323) when No is determined. The display control circuit finishes the turn on/turn off switching process after performing step S322 or S323.

As described above, in the display device according to the present embodiment, the display control circuit 25 controls the display panel 11 and the backlight 22 so that a plurality of subfields including the achromatic color subfield (white subfield) are displayed in one frame period, until detecting the turn off instruction (turn on/turn off switching signal C2). When detecting the turn off instruction, the display control circuit 25 retains the turn off instruction, and turns off the backlight 22 in accordance with the retained turn off instruction after controlling the display panel 11 and the backlight 22 so that the achromatic color subfield is displayed.

Therefore, in the display device which displays the achromatic color subfield in a normal state, it is possible to prevent the unnatural display when the backlight 22 is turned off, by displaying the achromatic color subfield before the backlight 22 is turned off. Furthermore, it is possible to easily perform a process when the turn off instruction is detected, by retaining the detected turn off instruction and turning off the backlight in accordance with the retained turn off instruction after displaying the achromatic color subfield.

### Reference Example

The display devices according to the first to third embodiments display the white subfield in one subfield period before turning off the backlight. As an example of such a display device, it is possible to configure a display device (hereinafter referred to as display device according to reference example) which receives a signal indicating a turn on/turn off state of the backlight together with a video signal from a video source.

FIG. 10 is a block diagram showing a configuration of a display device according to the reference example. A display device 40 shown in FIG. 10 is a field sequential color type display device. The display device 40 includes the display panel 11, the backlight 22, the panel drive circuit 13, the backlight drive circuit 14, and a display control circuit 45. A video source 6 is provided outside the display device 40. The video source 6 outputs the video signal V1 and a backlight control signal C3 to the display device 40. The backlight control signal C3 indicates the turn on/turn off state of the backlight 22.

The display control circuit 45 divides one frame period into n (n is an integer not less than 4) subfield periods, and controls the display panel 11 and the backlight 22 by outputting the backlight data D1 and the video signal V2 including the subfield data in each subfield period. In the n-th subfield period, the white subfield is displayed. In the following, it is assumed that n=4 and the blue, green, red, and white subfields are sequentially displayed in the first to fourth subfield periods.

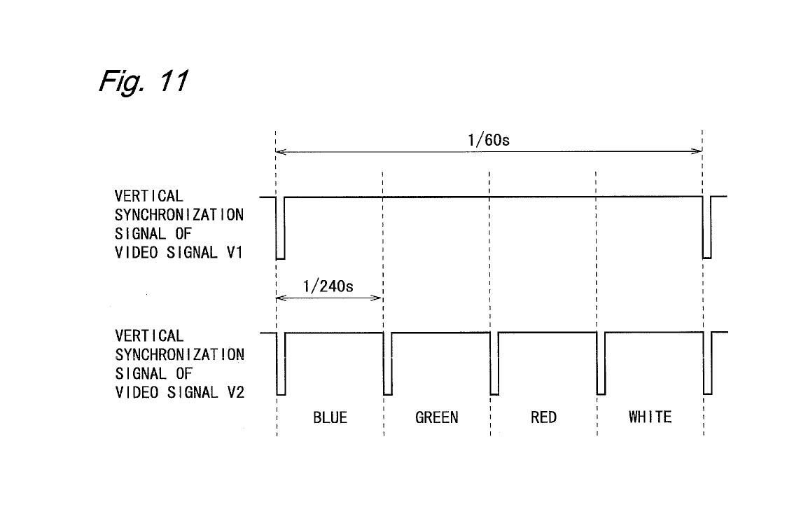

FIG. 11 is a diagram showing vertical synchronization signals of the video signals V1, V2 in the display device 40. As shown in FIG. 11, the vertical synchronization signal of the video signal V1 becomes an active level (low level) for a predetermined time with a period of 1/60 second. The vertical synchronization signal of the video signal V2 becomes the active level for a predetermined time with a period of 1/240 second. A time period in which the vertical synchronization signal of the video signal V1 is at the active level and a time period in which the vertical synchronization signal of the video signal V2 is at the active level in the first subfield period are synchronized.

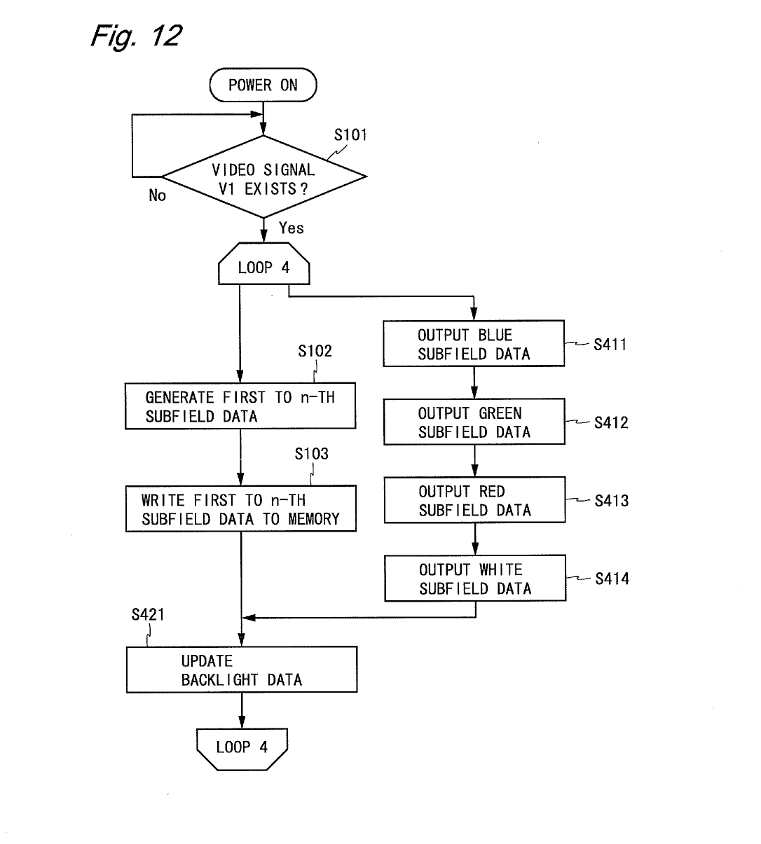

FIG. 12 is a flowchart showing operations of the display control circuit 45. FIG. 12 describes operations after power on. When the video signal V1 is output from the video source 6, the display control circuit 45 performs the data generation process and the data output process. The display control circuit 45 performs these processes repeatedly in parallel, each once in one frame period (loop 4). Details of the data generation process are the same as those of the first embodiment. The display control circuit 45 goes to step S421 after performing the data generation process.

In the data output process, at first, the display control circuit 45 outputs blue subfield data as the first subfield data together with the backlight data D1 indicating blue (step S411). With this, the blue subfield is displayed as the first subfield. Next, the display control circuit 45 outputs green subfield data as the second subfield data together with the backlight data D1 indicating green (step S412). With this, the green subfield is displayed as the second subfield. Next, the display control circuit 45 outputs red subfield data as the third subfield data together with the backlight data D1 indicating red (step S413). With this, the red subfield is displayed as the third subfield. Next, the display control circuit 45 outputs the white subfield data as the fourth subfield data together with the backlight data D1 indicating white (step S414). With this, the white subfield is displayed as the fourth subfield. Next, the display control circuit 45 goes to step S421.

In step S421, the display control circuit 45 updates the backlight data D1 based on the backlight control signal C3 output from the video source 6. When the backlight control signal C3 indicates turn on, the display control circuit 45 outputs the backlight data D1 indicating turn on. After that, the backlight 22 is turned on, and the light emission color of the backlight 22 becomes blue, green, red, and white in the first to fourth subfield periods, respectively. When the backlight control signal C3 indicates turn off, the display control circuit 45 outputs the backlight data D1 indicating turn off. After that, the backlight 22 is turned off. Next, the display control circuit 45 goes to an end of the loop 4.

In the display device 40 according to the reference example, the display control circuit 45 updates the backlight data D1 based on the backlight control signal C3, after controlling the display panel 11 and the backlight 22 so that the white subfield is displayed as the fourth subfield. When the backlight control signal C3 indicates turn off, the display control circuit 45 outputs the backlight data D1 indicating turn off, and the backlight 22 is turned off. Thus, the white subfield is displayed for one subfield period before the backlight 22 is turned off. Therefore, according to the display device 40 according to the reference example, similar effects attained by the display devices according to the first to third embodiments can be attained without performing the turn on/turn off switching process.

As for the display device according to each embodiment of the present invention, various types of variants can be configured. In the display device according to each embodiment, the display control circuit controls the display panel and the backlight so that one white subfield is displayed when the turn off instruction is detected. In a display device according to a variant of the present invention, when detecting the turn off instruction, the display control circuit may control the display panel and the backlight so that one achromatic color subfield is displayed, or may control the display panel and the backlight so that two or more achromatic color subfields (or white subfields) are displayed. The display device of the present invention may be a see-through type display device and does not have to be the see-through type display device.

### INDUSTRIAL APPLICABILITY

Since the display device of the present invention has a feature that unnatural display can be prevented when the backlight is turned off, the display device can be applied to various kinds of field sequential color type display devices, such as a field sequential color type liquid crystal display device.

### DESCRIPTION OF REFERENCE CHARACTERS

10, 20, 40: DISPLAY DEVICE
11: DISPLAY PANEL
12, 22: BACKLIGHT
13: PANEL DRIVE CIRCUIT
14: BACKLIGHT DRIVE CIRCUIT
15, 25, 45: DISPLAY CONTROL CIRCUIT
16: FINISH SIGNAL OUTPUT UNIT
17: MEMORY
26: TURN ON/TURN OFF SIGNAL OUTPUT UNIT

1. A field sequential color type display device comprising:
a display panel;
a backlight having a switchable light emission color,
a display control circuit configured to divide one frame period into a plurality of subfield periods, and control the display panel and the backlight by outputting subfield data and backlight data in each subfield period; and
a turn off instructing unit configured to output a turn off instruction of the backlight at an arbitrary timing, wherein
the display control circuit is configured to, when detecting the turn off instruction, turn off the backlight after controlling the display panel and the backlight so that an achromatic color subfield is displayed.

2. The display device according to claim 1, wherein the display control circuit is configured to detect the turn off instruction every subfield period.

3. The display device according to claim 2, wherein the display control circuit is configured to perform a finish process of the display panel after turning off the backlight in accordance with the turn off instruction.

4. The display device according to claim 2, wherein the display control circuit is configured to control the display panel and the backlight so that a subfield which follows a subfield displayed before displaying the achromatic color subfield is displayed, after turning off the backlight in accordance with the turn off instruction.

5. The display device according to claim 3, wherein the display control circuit is configured to control the display panel and the backlight so that a plurality of subfields not including the achromatic color subfield are displayed in one frame period, until detecting the turn off instruction.

6. The display device according to claim 2, wherein the display control circuit is configured to control the display panel and the backlight so that a plurality of subfields including the achromatic color subfield are displayed in one frame period until detecting the turn off instruction, retain the turn off instruction when detecting the turn off instruction, and turn off the backlight in accordance with the retained turn off instruction after controlling the display panel and the backlight so that the achromatic color subfield is displayed.

7. The display device according to claim 1, wherein the achromatic color subfield is a white subfield.

8. The display device according to claim 1, wherein the display control circuit is configured to, when detecting the turn off instruction, control the display panel and the backlight so that one achromatic color subfield is displayed.

9. The display device according to claim 1, wherein a part of the backlight that overlaps with the display panel is formed of a transparent material.

10. A control method for a field sequential color type display device including a display panel and a backlight having a switchable light emission color, the method comprising the steps of:
dividing one frame period into a plurality of subfield periods and controlling the display panel and the backlight by outputting subfield data and backlight data in each subfield period; and
outputting a turn off instruction of the backlight at an arbitrary timing, wherein
in the controlling, when the turn off instruction is detected, the backlight is turned off after controlling the display panel and the backlight so that an achromatic color subfield is displayed.

11. The display device according to claim 4, wherein the display control circuit is configured to control the display panel and the backlight so that a plurality of subfields not including the achromatic color subfield are displayed in one frame period, until detecting the turn off instruction.
